(19) United States
(12) Patent Application Publication
(10) Pub. No.: US 2010/0028540 A1
(43) Pub. Date: Feb. 4, 2010

(54) Method and system for forming black matrix

(76) Inventors: Jie-Hyun Seong, Daejeon (KR); Seung-Heon Lee, Seoul (KR); Hye-Jeong Lee, Gyeonggi-do (KR); Soon-Yeel Lee, Daejeon (KR); Kyoung-Su Jeon, Seoul (KR); Yang-Gu Kang, Daejeon (KR)

Correspondence Address: MCKENNA LONG & ALDRIDGE LLP, 1900 K STREET, NW, WASHINGTON, DC, 20006, US

(21) Appl. No.: 12/449,698

(22) PCT Filed: Mar. 7, 2008
(86) PCT No.: PCT/KR2008/001307

§ 371 Date: Aug. 21, 2009

(30) Foreign Application Priority Data
Mar. 9, 2007 (KR) 10-2007-0023708

(51) Int. Cl. B05D 5/00; B05C 11/02

(52) U.S. Cl. 427/256; 118/106

(57) ABSTRACT

A method for forming a black matrix includes (S1) applying a black matrix-forming ink to an intaglio-patterned elastic mold; (S2) removing an ink applied to an embossed portion of the elastic mold; (S3) transcribing the ink remaining in an intagliated portion of the elastic mold to a substrate; and (S4) curing and drying the ink transcribed to the substrate. The step (S2) may be performed in a way of closely adhering a surface of an ink removing unit having a surface energy from <a surface energy of the ink−2 erg/cm²> to <the surface energy of the ink+8 erg/cm²> to the embossed portion of the elastic mold and then taking away the ink removing unit from the embossed portion. This method allows forming a black matrix in a simple and economic way by applying the gravure process.

### TECHNICAL FIELD

The present invention relates to method and system for forming a black matrix of LCD (Liquid Crystal Display), and more particularly to method and system for forming a black matrix, which may form a black matrix in a simple and economic way by using a gravure process, and particularly form a high-quality black matrix by effectively removing a black matrix-forming ink formed on an embossed portion of an outer circumference of a printing roller during the gravure process.

### BACKGROUND ART

Recently, LCD (Liquid Crystal Display) is widely used as a device for displaying various images such as a still image and a moving image. Due to the improvement of liquid crystal materials and the development of fine pixel processing techniques together with the inherent features of light weight, thin design and low energy consumption, the quality of LCD is rapidly improved, and thus its application is more widely expanded.

A liquid crystal panel that is a basic component of the LCD is configured as follows. FIG. 1 is an exploded perspective view showing a part of a conventional LCD. Referring to FIG. 1, the conventional color LCD includes a color filter having a black matrix 6 and sub color filters (red, green, blue) 8, an upper substrate 5 having a transparent common electrode 18 formed on the color filter, and a lower substrate 22 on which an array wiring having a pixel region P, a pixel electrode 17 formed on the pixel region, and a switching element T is formed. Also, a liquid crystal 14, explained above, is filled between the upper substrate 5 and the lower substrate 22.

At this time, the upper substrate 5 is also called a color filter substrate, and the black matrix 6 plays a role of classifying the sub color filters 8 and shading light. In addition, the lower substrate 22 is also called an array substrate, and thin film transistors T that are the switching element are positioned thereon in a matrix pattern. Gate lines 13 and data lines 15 are formed to cross the plurality of thin film transistors. In addition, the pixel region P is defined by the gate lines 13 and the data lines 15, which cross each other. The pixel electrode 17 formed on the pixel region P uses a transparent conducting metal having a relatively excellent light transmittance such as indium-tin-oxide (ITO).

In the LCD configured as mentioned above, the liquid crystal layer 14 positioned on the pixel electrode 17 is aligned due to the signal applied from the thin film transistor, and an image may be expressed in a way of controlling an amount of light transmitting through the liquid crystal layer according to the degree of alignment of the liquid crystal layer.

That is to say, a desired color image is displayed while the light having passed through the pixel electrode 17 connected to the thin film transistor passes through each red, green or blue sub color filter 8 corresponding to each pixel electrode 17.

Here, the black matrix 6 plays a role of preventing light leakage. Generally, the black matrix 6 is formed in regions among red, green and blue patterns of the sub color filter 8 and regions where any pixel electrode is not formed on the lower substrate. The black matrix 6 is formed for the purpose of shading light leaked through a portion where a pixel electrode is not formed. In addition, the black matrix 6 intercepts direct light irradiation of the thin film transistor so as to prevent an increase of leaked current of the thin film transistor.

Such a conventional black matrix is manufactured using a photolithography method. However, the photolithography method has problems of complicated manufacturing processes and plenty wasted materials during the processes, and only a photosensitive resin is usable in forming the black matrix.

Thus, there have been persistent endeavors to solve the problems of the black matrix forming process, and the present invention is contrived under such background.

### DISCLOSURE

### Technical Problem

The present invention is designed to solve the problems of the prior art, and therefore it is an object of the present invention to provide a method for forming a black matrix, which allows forming a black matrix in a simple and economic way by applying a gravure process, and also allows forming a high-quality black matrix by improving the gravure process.

Another object of the present invention is to provide a system for forming a black matrix, which adopts the black matrix forming method.

### Technical Solution

In order to accomplish the above object, the present invention provides a method for forming a black matrix, which includes (S1) applying a black matrix-forming ink to an intaglio-patterned elastic mold; (S2) removing an ink applied to an embossed portion of the elastic mold; (S3) transcribing the ink remaining in an intagliated portion of the elastic mold to a substrate; and (S4) curing and drying the ink transcribed to the substrate.

In another aspect of the present invention, there is also provided a method for forming a black matrix, which includes (S1) applying a black matrix-forming ink to an intaglio-patterned elastic mold; (S2) removing an ink applied to an embossed portion of the elastic mold in a way of closely adhering a surface of an ink removing unit having a surface energy from <a surface energy of the ink−2 erg/cm²> to <the surface energy of the ink+8 erg/cm²> to the embossed portion of the elastic mold and then taking away the ink removing unit from the embossed portion; (S3) transcribing the ink remaining in an intagliated portion of the elastic mold to a substrate; and (S4) curing and drying the ink transcribed to the substrate.

In still another aspect of the present invention, there is also provided a system for forming a black matrix, which includes a printing roller having an outer circumference that is an intaglio-patterned elastic mold, the printing roller rotating around a central axis thereof to transcribe a black matrix-forming ink filled in an intagliated portion of the outer circumference to a substrate; an ink applying unit for supplying and applying the ink to the outer circumference of the printing roller; an ink removing belt rotating in close contact with an embossed portion of the outer circumference of the printing roller to remove an ink applied to the embossed portion of the outer circumference of the printing roller, the ink removing belt having a material with a surface energy from <a surface energy of the ink−2 erg/cm²> to <the surface energy of the ink+8 erg/cm²>; and a belt rotating unit for successively rotating the ink removing belt.

In further another aspect of the present invention, there is also provided a system for forming a black matrix, which includes a printing roller having an outer circumference that is an intaglio-patterned elastic mold, the printing roller rotating around a central axis thereof to transcribe a black matrix-forming ink filled in an intagliated portion of the outer circumference to a substrate; an ink applying unit for supplying and applying the ink to the outer circumference of the printing roller; and an ink removing roller rotating in close contact with an embossed portion of the outer circumference of the printing roller to remove an ink applied to the embossed portion of the outer circumference of the printing roller, the ink removing roller having a material with a surface energy from <a surface energy of the ink−2 erg/cm²> to <the surface energy of the ink+8 erg/cm²>.

### DESCRIPTION OF DRAWINGS

Other objects and aspects of the present invention will become apparent from the following description of embodiments with reference to the accompanying drawing in which:

FIG. 1 is an exploded perspective view showing a part of a conventional LCD;

FIG. 2 is a schematic view showing a system for forming a black matrix according to one embodiment of the present invention;

FIG. 3 is a schematic view showing a system for forming a black matrix according to another embodiment of the present invention;

FIGS. 4 to 8 are photographs showing black matrixes according to embodiments 1 to 3 and comparative examples 1 and 2, respectively.

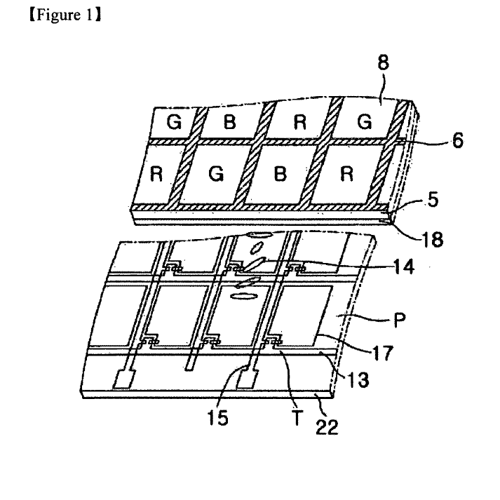

### BEST MODE

Hereinafter, preferred embodiments of the present invention will be described in detail with reference to the accompanying drawings.

The present invention provides method and system for forming a black matrix, to which a gravure process is applied to solve the problem of a conventional black matrix forming method using photolithography.

The gravure process is a printing method in which a material to be patterned (hereinafter, referred to as an ink) is applied to an intaglio mold, an ink remaining on an embossed portion is removed using a knife such as a doctor blade, and then a pattern is formed on a substrate. The present invention allows more simple and economic processes by applying the gravure process in forming a black matrix.

The method for forming a black matrix according to the present invention includes the steps of applying a black matrix-forming ink to an intaglio-patterned elastic mold, removing an ink applied to an embossed portion of the elastic mold, transcribing the ink remaining in an intagliated portion of the elastic mold to a substrate, and curing and drying the ink transcribed to the substrate.

In the black matrix forming method using a gravure process as mentioned above, the ink applied to the embossed portion of the elastic mold may be easily removed in a way of closely adhering a surface of an ink removing unit with a surface energy similar to the ink toward the embossed portion of the elastic mold and then taking away the ink removing unit from the embossed portion. Preferably, the ink applied to the embossed portion of the elastic mold may be more effectively removed in a way of closely adhering the surface of the ink removing unit with a surface energy from <a surface energy of the ink−2 erg/cm²> to <the surface energy of the ink+8 erg/cm²> to the embossed portion of the elastic mold and then taking away the ink removing unit from the embossed portion. The ink removing unit may be made using a material with the above surface energy, or only the surface of the ink removing unit may be made using such a material.

The ink removing unit may be a film, a sheet or a roll containing a polymer resin with a surface energy from <a surface energy of the ink−2 erg/cm²> to <the surface energy of the ink+8 erg/cm²>, or the ink removing unit may be configured by forming a polymer resin layer, an organic material layer or an organic/inorganic composite layer with a surface energy from <a surface energy of the ink−2 erg/cm²> to <the surface energy of the ink+8 erg/cm²> on a support that is a film, a sheet or a roll. At this time, the support may be made of plastic, carbon, metal, ceramic and so on.

The ink used for forming a black matrix generally includes pigment, binder, dispersing agent, surfactant, curing agent, initiator and solvent, and the ink used for forming a black matrix generally has a surface energy of 23 to 42 erg/cm².

In case the black matrix-forming ink has a surface energy of 23 to 32 erg/cm², the polymer resin may representatively contain any material selected from the group consisting of polypropylene, poly(N-butylmethacrylate), poly(laurylmethacrylate), polyethylene, polyisobutylene, polyvinylfluoride, polytrifluoroethylene, polychlorotrifluoroethylene, polyoctylmethacrylate, polyvinylacetate, polyethylacrylate, polyethylmethacrylate, polyisobutylmethacrylate, polybutylacrylate, poly(t-butylmethacrylate), polymethacrylonitrile, polyhexylmethacrylate, polypropylmethacrylate, polyethylhexylacrylate, polytetramethyleneoxide, polyphenylmethacrylate, polystearylmethacrylate, polycarbonate, polyvinylidenefluoride, polybenzylmethacrylate, polyvinylbutyral, polyepichlorohydrin, nitrocellulose, cellulose acetate butyrate, ethyl cellulose, polyoxymethylene, polypropyleneoxide, nylon 11, nylon 10,10, nylon 88, nylon 99, polyvinylalcohol, polydiethylsiloxane, polymethylphenylsiloxane, poly(di-n-hexylsilane), poly(di-n-propylsilane), poly(di-n-butylsilane), polycyclohexylmethyl, polydimethylsilane, poly(paratoluenemethylsilane), polyphenylethylsilane, and their mixtures, and the organic material layer and the organic/inorganic composite layer may representatively contain diphenyldichlorosilane, octadecylamine, hexatriacontane, paraffin wax, or their mixtures.

In case the black matrix-forming ink has a surface energy of 33 to 43 erg/cm², the polymer resin may representatively contain any material selected from the group consisting of polyethylene, polyisobutylene, polystyrene, polyalphamethylstyrene, polyvinylfluoride, polyvinylchloride, polyphenylmethylsilane, poly(paratoluenemethylsilane), polyphenylethylsilane, polydimethylsilane, polyvinylidenechloride, polychlorotrifluoroethylene, polychloroprene, polyvinylacetate, polymethylacrylate, polystearylmethacrylate, polyethylacrylate, polymethylmethacrylate, polyphenylmethacrylate, poly(laurylmethacrylate), polyepichlorohydrin, polypropylmethacrylate, polyethylmethacrylate, polybutylacrylate, polybutylmethacrylate, polyisobutylmethacrylate, polyethyleneoxide, polypropyleneoxide, polyoxymethylene, polytetramethyleneoxide, polybenzylmethacrylate, polydimethylaminoethylmethacrylate, poly(t-butylaminoethylmethacrylate), polyhydroxyethylmethacrylate, polyethyleneterephthalate, nylon 6, nylon 66, nylon 11, nylon 77, polyamide 12, nylon 88, nylon 99, polyacrylonitrile, polymethacrylonitrile, polycarbonate, polyetheretherketone, amine-cured epoxy resin, wool, cellulose acetate butyrate, nitrocellulose, ethyl cellulose, polyvinylbutyral, polyvinylalcohol, polydiphenylsilane, poly(paratoluylethylmethylsilane), polyphenylmethylsilane, and their mixtures, and the organic material layer and the organic/inorganic composite layer may representatively contain paraffin wax, aminopropyltriethoxysilane, aminopropyltrimethoxysilane, glycydoxypropyltrimethoxysilane, or their mixtures.

If a knife such as a doctor blade is used during the gravure process using an elastic mold, the elastic mold may make even an ink in an intagliated portion be removed due to its elasticity. However, the black matrix forming method of the present invention allows effectively removing only the ink applied to the embossed portion without removing the ink filled in the intagliated portion.

The present invention also provides a system for forming a black matrix, which may be utilized for the black matrix forming method.

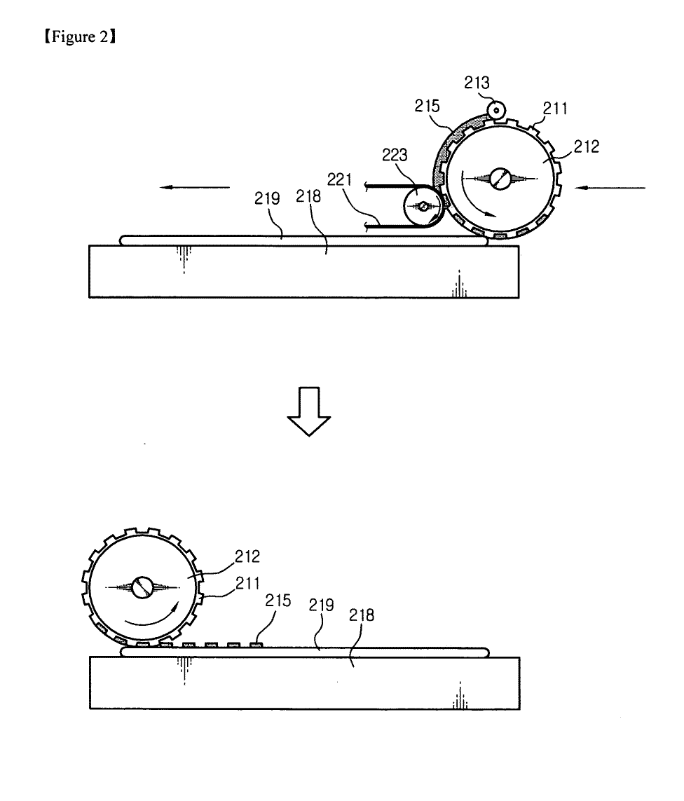

FIG. 2 is a schematic view showing a system for forming a black matrix according to one embodiment of the present invention. Referring to FIG. 2, the black matrix forming system of this embodiment includes a printing roller 211, 212 having an outer circumference that is an intaglio-patterned elastic mold and rotating around a central axis thereof to transcribe a black matrix-forming ink 215 filled in an intagliated portion of the outer circumference to a substrate; an ink applying unit 213 for supplying and applying the black matrix-forming ink 215 to the outer circumference of the printing roller 211, 212; an ink removing belt 221 rotating in close contact with an embossed portion of the outer circumference of the printing roller 211, 212 to remove an ink 215 applied to the embossed portion of the outer circumference of the printing roller 211, 212 and having a material with a surface energy from <a surface energy of the ink−2 erg/cm²> to <the surface energy of the ink+8 erg/cm²>; and a belt rotating unit 223 for successively rotating the ink removing belt 221.

In the black matrix forming system, the printing roller 211, 212 transcribes the black matrix-forming ink 215 onto the substrate while rotating and moving in close contact with an upper surface of the substrate. At this time, the ink applying unit 213 supplies and applies the black matrix-forming ink 215 to the outer circumference of the printing roller 211, 212, and the printing roller 211, 212 successively applies the ink over the entire outer circumference while rotating in an arrowed direction. The ink may be applied to the outer circumference of the printing roller in various ways such as Meier bar coating, micro gravure coating, gravure coating, blade coating, spray coating, slot die coating, and roll coating.

The ink removing belt 221 successively removes the ink 215 applied to the embossed portion of the outer circumference of the printing roller 211, 212 before the ink 215 applied to the printing roller 211, 212 is transcribed to the substrate. The ink removing belt 221 contains a polymer resin with a surface energy similar to the surface energy of the ink 215 as a main component as mentioned above, so it gives an excellent ink removing effect. If the ink 215 on the embossed portion of the outer circumference of the printing roller 211, 212 is removed, the ink 215 filled in the intagliated portion of the outer circumference of the printing roller 211, 212 is applied onto the substrate. The belt rotating unit 223 is installed to the black matrix forming system for successive rotation of the ink removing belt, and the substrate 219 may be fixed on a support 218 to prevent shaking.

In this embodiment, the ink removing belt 221 is used as the ink removing unit, and the belt rotating unit 223 is used for rotating the ink removing belt 221. However, an ink removing roller may also be used as the ink removing unit instead of the ink removing belt 221 and the belt rotating unit 223. This ink removing roller rotates in close contact with the embossed portion of the outer circumference of the printing roller and then removes an ink supplied from the ink applying unit and applied to the embossed portion of the outer circumference of the printing roller.

The black matrix forming system of the present invention may further include a holding roller, and the holding roller plays a role of holding and carrying a substrate together with the printing roller in case the substrate is a film-type substrate. In addition, the black matrix forming system may further include a drying device for drying the ink applied onto the substrate.

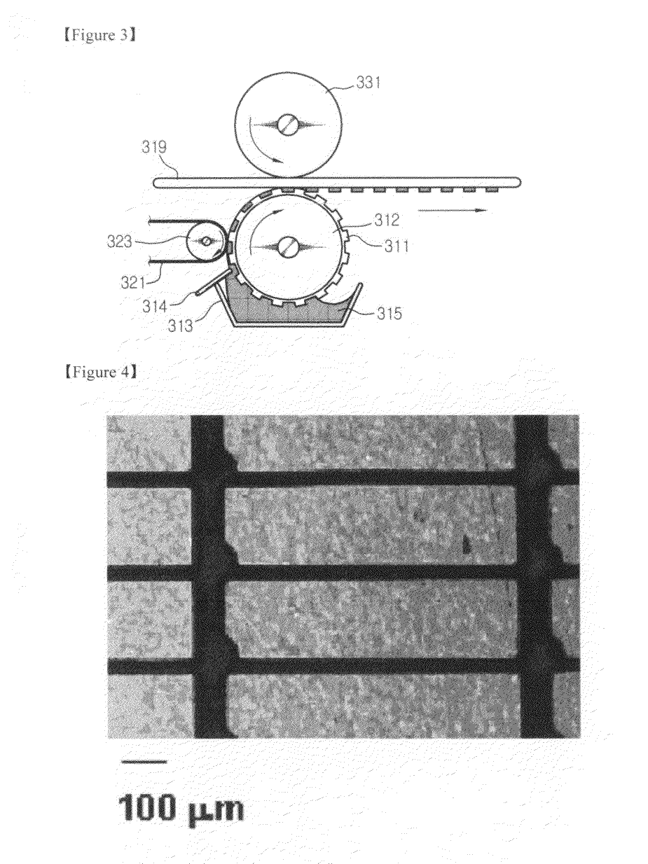

FIG. 3 is a schematic view showing a system for forming a black matrix according to another embodiment of the present invention. According to the black matrix forming system of this embodiment, as a film-type substrate 319 passes between a holding roller 331 and a printing roller 311, 312, an ink 315 filled in an intagliated portion of an elastic mold 311 fixed to a body 312 of the printing roller is applied to the substrate. At this time, the printing roller 311, 312 and the holding roller 331 keep rotating to apply the ink 315 to a surface of the substrate 319 successively. The printing roller 311, 312 is supplied with ink 315 from an ink applying unit 313 while rotating, and the surface of an elastic mold 311 is coated with the ink 315. If the surface of the elastic mold 311 is coated with the ink 315, the ink 315 is firstly uniformly applied to the entire surface of the elastic mold 311 by means of an ink flattening unit 314, and an ink 315 applied to an embossed portion on the surface of the elastic mold 311 is removed by means of an ink removing belt 321 rotated by a belt rotating unit 323.

In the above black matrix forming systems, in case the ink has a surface energy of 23 to 32 erg/cm², the ink removing belt and the ink removing roller may contain any material selected from the group consisting of polypropylene, poly(N-butylmethacrylate), poly(laurylmethacrylate), polyethylene, polyisobutylene, polyvinylfluoride, polytrifluoroethylene, polychlorotrifluoroethylene, polyoctylmethacrylate, polyvinylacetate, polyethylacrylate, polyethylmethacrylate, polyisobutylmethacrylate, polybutylacrylate, poly(t-butylmethacrylate), polymethacrylonitrile, polyhexylmethacrylate, polypropylmethacrylate, polyethylhexylacrylate, polytetramethyleneoxide, polyphenylmethacrylate, polystearylmethacrylate, polycarbonate, polyvinylidenefluoride, polybenzylmethacrylate, polyvinylbutyral, polyepichlorohydrin, nitrocellulose, cellulose acetate butyrate, ethyl cellulose, polyoxymethylene, polypropyleneoxide, nylon 11, nylon 10,10, nylon 88, nylon 99, polyvinylalcohol, polydiethylsiloxane, polymethylphenylsiloxane, poly(di-n-hexylsilane), poly(di-n-propylsilane), poly(di-n-butylsilane), polycyclohexylmethyl, polydimethylsilane, poly(paratoluenemethylsilane), polyphenylethylsilane, diphenyldichlorosilane, octadecylamine, hexatriacontane, paraffin wax, and their mixtures.

In addition, in case the ink has a surface energy of 33 to 43 erg/cm², the ink removing belt and the ink removing roller may contain any material selected from the group consisting of polyethylene, polyisobutylene, polystyrene, polyalphamethylstyrene, polyvinylfluoride, polyvinylchloride, polyphenylmethylsilane, poly(paratoluenemethylsilane), polyphenylethylsilane, polydimethylsilane, polyvinylidenechloride, polychlorotrifluoroethylene, polychloroprene, polyvinylacetate, polymethylacrylate, polystearylmethacrylate, polyethylacrylate, polymethylmethacrylate, polyphenylmethacrylate, poly(laurylmethacrylate), polyepichlorohydrin, polypropylmethacrylate, polyethylmethacrylate, polybutylacrylate, polybutylmethacrylate, polyisobutylmethacrylate, polyethyleneoxide, polypropyleneoxide, polyoxymethylene, polytetramethyleneoxide, polybenzylmethacrylate, polydimethylaminoethylmethacrylate, poly(t-butylaminoethylmethacrylate), polyhydroxyethylmethacrylate, polyethyleneterephthalate, nylon 6, nylon 66, nylon 11, nylon 77, polyamide 12, nylon 88, nylon 99, polyacrylonitrile, polymethacrylonitrile, polycarbonate, polyetheretherketone, amine-cured epoxy resin, wool, cellulose acetate butyrate, nitrocellulose, ethyl cellulose, polyvinylbutyral, polyvinylalcohol, polydiphenylsilane, poly(paratoluylethylmethylsilane), polyphenylmethylsilane, paraffin wax, aminopropyltriethoxysilane, aminopropyltrimethoxysilane, glycydoxypropyltrimethoxysilane, and their mixtures.

### MODE FOR INVENTION

Hereinafter, the present invention is explained in more detail based on embodiments. However, the embodiments of the present invention may be modified in various ways, and it should be not interpreted that the scope of the present invention is limited to the following embodiments. The embodiments are provided just for better understanding of the present invention to those having ordinary skill in the art.

### Embodiment 1

A pattern surface of an elastic mold having PDMS as a main component was bar-coated with a polymer resin solution having a surface energy of 29 to 30 erg/cm² by using a Meyer bar No. 5. After that, a polypropylene roll having a surface energy of 30 to 32 erg/cm² was rolled on the surface of the elastic mold coated with the polymer resin solution, thereby removing a polymer resin on a surface of a relatively protruded embossed portion of the elastic mold by means of the surface of the polypropylene roll. In this way, the polymer resin was selectively filled in an intagliated portion of the elastic mold. After that, the elastic mold was closely adhered to a PET substrate, and then, after a weak pressure is applied thereto, the elastic mold was taken away from the PET substrate such that a fine pattern of polymer rein was formed on the PET substrate.

### Embodiment 2

A pattern surface of an elastic mold having PDMS as a main component was bar-coated with a polymer resin solution having a surface energy of 29 to 30 erg/cm² by using a Meyer bar No. 5. After that, a polypropylene sheet having a surface energy of 30 to 32 erg/cm² was rolled on the surface of the elastic mold coated with the polymer resin solution, thereby removing a polymer resin on a surface of a relatively protruded embossed portion of the elastic mold by means of the surface of the polypropylene sheet. In this way, the polymer resin was selectively filled in an intagliated portion of the elastic mold. After that, the elastic mold was closely adhered to a glass substrate, and then, after a weak pressure is applied thereto, the elastic mold was taken away from the glass substrate such that a fine pattern of polymer rein was formed on the glass substrate.

### Embodiment 3

A pattern surface of an elastic mold having PDMS as a main component was bar-coated with a polymer resin solution having a surface energy of 29 to 30 erg/cm² by using a Meyer bar No. 5. After that, poly(butyl methacrylate) having a surface energy of 31 erg/cm² was applied to a surface of a PET sheet to make a poly(butyl methacrylate) film, and the poly(butyl methacrylate) film was rolled on the surface of the elastic mold coated with the polymer resin solution, thereby taking off a polymer resin on a surface of a relatively protruded embossed portion of the elastic mold by means of the surface of the poly(butyl methacrylate) film. In this way, the polymer resin was selectively filled in an intagliated portion of the elastic mold. After that, the elastic mold was closely adhered to a glass substrate, and then, after a weak pressure is applied thereto, the elastic mold was taken away from the glass substrate such that a fine pattern of polymer rein was formed on the glass substrate.

### Comparative Examples 1 and 2

A fine pattern was formed in the same way as the embodiment 2, except that a PET sheet (the comparative example 1) having a surface energy of 46.7 erg/cm² (literature value) and a PDMS sheet (the comparative example 2) having a surface energy of 22.8 erg/cm² were used instead of the polypropylene sheet.

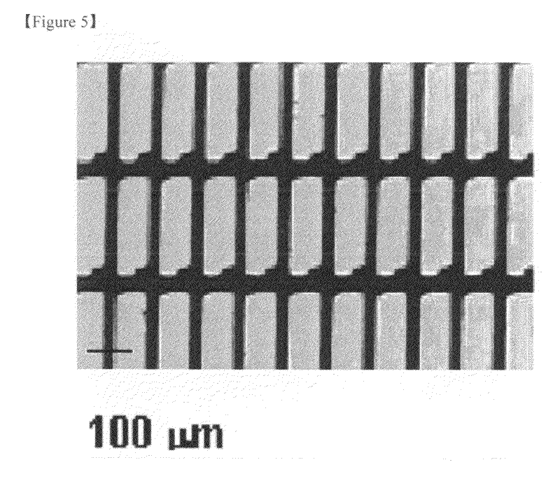

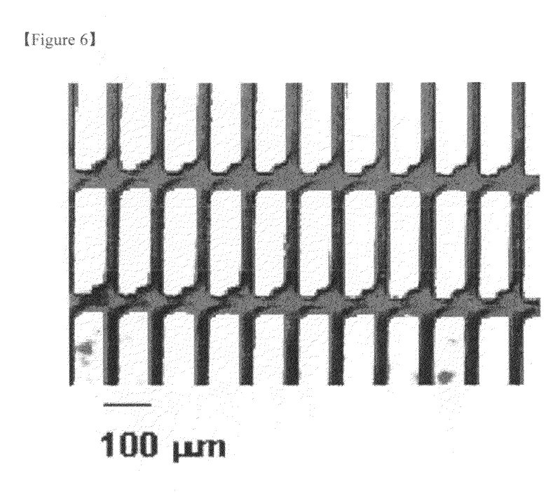

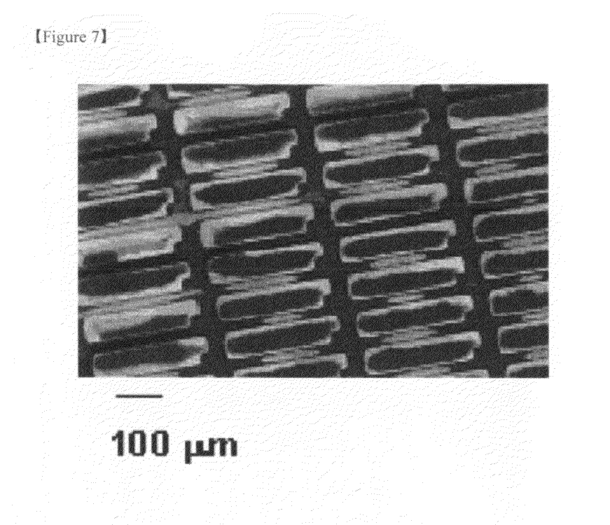

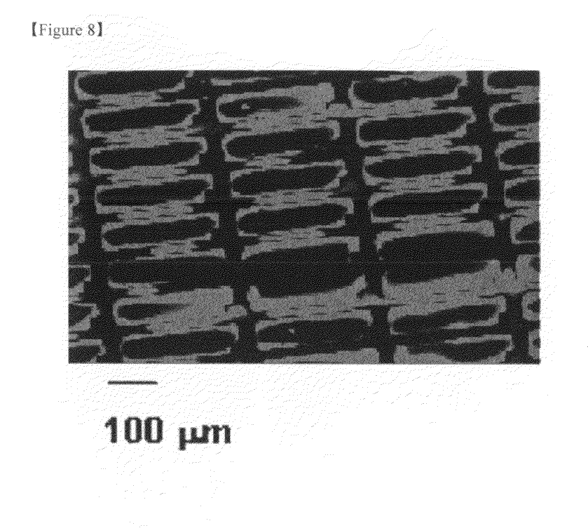

FIGS. 4 to 8 are photographs showing fine patterns according to the embodiments 1 to 3 and the comparative examples 1 and 2, respectively. In the fine patterns according to the embodiments 1 to 3 of the present invention (see FIGS. 4 to 6), it would be found that residuals on the embossed portion of the printing roller are completely removed, and so the polymer resin solution in the intagliated portion is clearly printed. However, in the fine patterns according to the comparative examples 1 and 2 (see FIGS. 7 and 8), it would be understood that residuals on the embossed portion are printed, so the fine patterns are unclear.

It should be understood that the terms used in the specification and appended claims should not be construed as being limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

### INDUSTRIAL APPLICABILITY

According to the black matrix forming method of the present invention, it is possible to form a black matrix in a simple and economic way by applying the gravure process. In particular, since the ink removing unit having a polymer resin with a surface energy similar to ink is used during the gravure process for forming a black matrix, the ink applied to an embossed portion of the printing roller may be effectively removed, but the ink filled in an intagliated portion is not removed during the gravure process using an elastic mold. Thus, the present invention allows forming a black matrix of high quality.

1. A method for forming a black matrix, comprising:
(S1) applying a black matrix-forming ink to an intaglio-patterned elastic mold;
(S2) removing an ink applied to an embossed portion of the elastic mold;
(S3) transcribing the ink remaining in an intagliated portion of the elastic mold to a substrate; and
(S4) curing and drying the ink transcribed to the substrate.

2. A method for forming a black matrix, comprising:
(S1) applying a black matrix-forming ink to an intaglio-patterned elastic mold;
(S2) removing an ink applied to an embossed portion of the elastic mold in a way of closely adhering a surface of an ink removing unit having a surface energy from <a surface energy of the ink−2 erg/cm²> to <the surface energy of the ink+8 erg/cm²> to the embossed portion of the elastic mold and then taking away the ink removing unit from the embossed portion;
(S3) transcribing the ink remaining in an intagliated portion of the elastic mold to a substrate; and
(S4) curing and drying the ink transcribed to the substrate.

3. The method for forming a black matrix according to claim 2,
wherein the ink removing unit is a film, a sheet or a roll containing a polymer resin with a surface energy from <a surface energy of the ink−2 erg/cm²> to <the surface energy of the ink+8 erg/cm²>, or the ink removing unit is configured by forming a polymer resin layer, an organic material layer or an organic/inorganic composite layer with a surface energy from <a surface energy of the ink−2 erg/cm²> to <the surface energy of the ink+8 erg/cm²> on a support that is a film, a sheet or a roll.

4. The method for forming a black matrix according to claim 3,
wherein, in case the black matrix-forming ink has a surface energy of 23 to 32 erg/cm², the polymer resin contains any material selected from the group consisting of polypropylene, poly(N-butylmethacrylate), poly(laurylmethacrylate), polyethylene, polyisobutylene, polyvinylfluoride, polytrifluoroethylene, polychlorotrifluoroethylene, polyoctylmethacrylate, polyvinylacetate, polyethylacrylate, polyethylmethacrylate, polyisobutylmethacrylate, polybutylacrylate, poly(t-butylmethacrylate), polymethacrylonitrile, polyhexylmethacrylate, polypropylmethacrylate, polyethylhexylacrylate, polytetramethyleneoxide, polyphenylmethacrylate, polystearylmethacrylate, polycarbonate, polyvinylidenefluoride, polybenzylmethacrylate, polyvinylbutyral, polyepichlorohydrin, nitrocellulose, cellulose acetate butyrate, ethyl cellulose, polyoxymethylene, polypropyleneoxide, nylon 11, nylon 10,10, nylon 88, nylon 99, polyvinylalcohol, polydiethylsiloxane, polymethylphenylsiloxane, poly(di-n-hexylsilane), poly(di-n-propylsilane), poly(di-n-butylsilane), polycyclohexylmethyl, polydimethylsilane, poly(paratoluenemethylsilane), polyphenylethylsilane, and their mixtures, and the organic material layer and the organic/inorganic composite layer contain diphenyldichlorosilane, octadecylamine, hexatriacontane, paraffin wax, or their mixtures.

5. The method for forming a black matrix according to claim 3,
wherein, in case the black matrix-forming ink has a surface energy of 33 to 43 erg/cm², the polymer resin contains any material selected from the group consisting of polyethylene, polyisobutylene, polystyrene, polyalphamethylstyrene, polyvinylfluoride, polyvinylchloride, polyphenylmethylsilane, poly(paratoluenemethylsilane), polyphenylethylsilane, polydimethylsilane, polyvinylidenechloride, polychlorotrifluoroethylene, polychloroprene, polyvinylacetate, polymethylacrylate, polystearylmethacrylate, polyethylacrylate, polymethylmethacrylate, polyphenylmethacrylate, poly(laurylmethacrylate), polyepichlorohydrin, polypropylmethacrylate, polyethylmethacrylate, polybutylacrylate, polybutylmethacrylate, polyisobutylmethacrylate, polyethyleneoxide, polypropyleneoxide, polyoxymethylene, polytetramethyleneoxide, polybenzylmethacrylate, polydimethylaminoethylmethacrylate, poly(t-butylaminoethylmethacrylate), polyhydroxyethylmethacrylate, polyethyleneterephthalate, nylon 6, nylon 66, nylon 11, nylon 77, polyamide 12, nylon 88, nylon 99, polyacrylonitrile, polymethacrylonitrile, polycarbonate, polyetheretherketone, amine-cured epoxy resin, wool, cellulose acetate butyrate, nitrocellulose, ethyl cellulose, polyvinylbutyral, polyvinylalcohol, polydiphenylsilane, poly(paratoluylethylmethylsilane), polyphenylmethylsilane, and their mixtures, and the organic material layer and the organic/inorganic composite layer contain paraffin wax, aminopropyltriethoxysilane, aminopropyltrimethoxysilane, glycydoxypropyltrimethoxysilane, or their mixtures.

6. A system for forming a black matrix, comprising:
a printing roller having an outer circumference that is an intaglio-patterned elastic mold, the printing roller rotating around a central axis thereof to transcribe a black matrix-forming ink filled in an intagliated portion of the outer circumference to a substrate;
an ink applying unit for supplying and applying the ink to the outer circumference of the printing roller;
an ink removing belt rotating in close contact with an embossed portion of the outer circumference of the printing roller to remove an ink applied to the embossed portion of the outer circumference of the printing roller, the ink removing belt having a material with a surface energy from <a surface energy of the ink−2 erg/cm²> to <the surface energy of the ink+8 erg/cm²>; and
a belt rotating unit for successively rotating the ink removing belt.

7. The system for forming a black matrix according to claim 6,
wherein the ink applying unit applies the ink to the outer circumference of the printing roller by means of an applying manner selected from the group consisting of Meier bar coating, roll coating, micro gravure coating, blade coating, and slot die coating.

8. The system for forming a black matrix according to claim 6,
wherein, in case the ink has a surface energy of 23 to 32 erg/cm², the ink removing belt contains any material selected from the group consisting of polypropylene, poly(N-butylmethacrylate), poly(laurylmethacrylate), polyethylene, polyisobutylene, polyvinylfluoride, polytrifluoroethylene, polychlorotrifluoroethylene, polyoctylmethacrylate, polyvinylacetate, polyethylacrylate, polyethylmethacrylate, polyisobutylmethacrylate, polybutylacrylate, poly(t-butylmethacrylate), polymethacrylonitrile, polyhexylmethacrylate, polypropylmethacrylate, polyethylhexylacrylate, polytetramethyleneoxide, polyphenylmethacrylate, polystearylmethacrylate, polycarbonate, polyvinylidenefluoride, polybenzylmethacrylate, polyvinylbutyral, polyepichlorohydrin, nitrocellulose, cellulose acetate butyrate, ethyl cellulose, polyoxymethylene, polypropyleneoxide, nylon 11, nylon 10,10, nylon 88, nylon 99, polyvinylalcohol, polydiethylsiloxane, polymethylphenylsiloxane, poly(di-n-hexylsilane), poly(di-n-propylsilane), poly(di-n-butylsilane), polycyclohexylmethyl, polydimethylsilane, poly(paratoluenemethylsilane), polyphenylethylsilane, diphenyldichlorosilane, octadecylamine, hexatriacontane, paraffin wax, and their mixtures.

9. The system for forming a black matrix according to claim 6,
wherein, in case the ink has a surface energy of 33 to 43 erg/cm², the ink removing belt contains any material selected from the group consisting of polyethylene, polyisobutylene, polystyrene, polyalphamethylstyrene, polyvinylfluoride, polyvinylchloride, polyphenylmethylsilane, poly(paratoluenemethylsilane), polyphenylethylsilane, polydimethylsilane, polyvinylidenechloride, polychlorotrifluoroethylene, polychloroprene, polyvinylacetate, polymethylacrylate, polystearylmethacrylate, polyethylacrylate, polymethylmethacrylate, polyphenylmethacrylate, poly(laurylmethacrylate), polyepichlorohydrin, polypropylmethacrylate, polyethylmethacrylate, polybutylacrylate, polybutylmethacrylate, polyisobutylmethacrylate, polyethyleneoxide, polypropyleneoxide, polyoxymethylene, polytetramethyleneoxide, polybenzylmethacrylate, polydimethylaminoethylmethacrylate, poly(t-butylaminoethylmethacrylate), polyhydroxyethylmethacrylate, polyethyleneterephthalate, nylon 6, nylon 66, nylon 11, nylon 77, polyamide 12, nylon 88, nylon 99, polyacrylonitrile, polymethacrylonitrile, polycarbonate, polyetheretherketone, amine-cured epoxy resin, wool, cellulose acetate butyrate, nitrocellulose, ethyl cellulose, polyvinylbutyral, polyvinylalcohol, polydiphenylsilane, poly(paratoluylethylmethylsilane), polyphenylmethylsilane, paraffin wax, aminopropyltriethoxysilane, aminopropyltrimethoxysilane, glycydoxypropyltrimethoxysilane, and their mixtures.

10. The system for forming a black matrix according to claim 6, further comprising a holding roller,
wherein the holding roller is spaced apart from the printing roller such that a film-type substrate is held and carried between the holding roller and the printing roller.

11. The system for forming a black matrix according to claim 6, further comprising a drying device for drying the ink applied onto the substrate.

12. A system for forming a black matrix, comprising:
a printing roller having an outer circumference that is an intaglio-patterned elastic mold, the printing roller rotating around a central axis thereof to transcribe a black matrix-forming ink filled in an intagliated portion of the outer circumference to a substrate;
an ink applying unit for supplying and applying the ink to the outer circumference of the printing roller; and
an ink removing roller rotating in close contact with an embossed portion of the outer circumference of the printing roller to remove an ink applied to the embossed portion of the outer circumference of the printing roller, the ink removing roller having a material with a surface energy from <a surface energy of the ink−2 erg/cm²> to <the surface energy of the ink+8 erg/cm²>.

13. The system for forming a black matrix according to claim 12,
wherein, in case the ink has a surface energy of 23 to 32 erg/cm², the ink removing roller contains any material selected from the group consisting of polypropylene, poly(N-butylmethacrylate), poly(laurylmethacrylate), polyethylene, polyisobutylene, polyvinylfluoride, polytrifluoroethylene, polychlorotrifluoroethylene, polyoctylmethacrylate, polyvinylacetate, polyethylacrylate, polyethylmethacrylate, polyisobutylmethacrylate, polybutylacrylate, poly(t-butylmethacrylate), polymethacrylonitrile, polyhexylmethacrylate, polypropylmethacrylate, polyethylhexylacrylate, polytetramethyleneoxide, polyphenylmethacrylate, polystearylmethacrylate, polycarbonate, polyvinylidenefluoride, polybenzylmethacrylate, polyvinylbutyral, polyepichlorohydrin, nitrocellulose, cellulose acetate butyrate, ethyl cellulose, polyoxymethylene, polypropyleneoxide, nylon 11, nylon 10,10, nylon 88, nylon 99, polyvinylalcohol, polydiethylsiloxane, polymethylphenylsiloxane, poly(di-n-hexylsilane), poly(di-n-propylsilane), poly(di-n-butylsilane), polycyclohexylmethyl, polydimethylsilane, poly(paratoluenemethylsilane), polyphenylethylsilane, diphenyldichlorosilane, octadecylamine, hexatriacontane, paraffin wax, and their mixtures.

14. The system for forming a black matrix according to claim 12,
wherein, in case the ink has a surface energy of 33 to 43 erg/cm², the polymer resin contains any material selected from the group consisting of polyethylene, polyisobutylene, polystyrene, polyalphamethylstyrene, polyvinylfluoride, polyvinylchloride, polyphenylmethylsilane, poly(paratoluenemethylsilane), polyphenylethylsilane, polydimethylsilane, polyvinylidenechloride, polychlorotrifluoroethylene, polychloroprene, polyvinylacetate, polymethylacrylate, polystearylmethacrylate, polyethylacrylate, polymethylmethacrylate, polyphenylmethacrylate, poly(laurylmethacrylate), polyepichlorohydrin, polypropylmethacrylate, polyethylmethacrylate, polybutylacrylate, polybutylmethacrylate, polyisobutylmethacrylate, polyethyleneoxide, polypropyleneoxide, polyoxymethylene, polytetramethyleneoxide, polybenzylmethacrylate, polydimethylaminoethylmethacrylate, poly(t-butylaminoethylmethacrylate), polyhydroxyethylmethacrylate, polyethyleneterephthalate, nylon 6, nylon 66, nylon 11, nylon 77, polyamide 12, nylon 88, nylon 99, polyacrylonitrile, polymethacrylonitrile, polycarbonate, polyetheretherketone, amine-cured epoxy resin, wool, cellulose acetate butyrate, nitrocellulose, ethyl cellulose, polyvinylbutyral, polyvinylalcohol, polydiphenylsilane, poly(paratoluylethylmethylsilane), polyphenylmethylsilane, paraffin wax, aminopropyltriethoxysilane, aminopropyltrimethoxysilane, glycydoxypropyltrimethoxysilane, and their mixtures.

15. The system for forming a black matrix according to claim 12,
wherein the ink applying unit applies the ink to the outer circumference of the printing roller by means of an applying manner selected from the group consisting of Meier bar coating, roll coating, micro gravure coating, blade coating, and slot die coating.

16. The system for forming a black matrix according to claim 12, further comprising a holding roller,
wherein the holding roller is spaced apart from the printing roller such that a film-type substrate is held and carried between the holding roller and the printing roller.

17. The system for forming a black matrix according to claim 12, further comprising a drying device for drying the ink applied onto the substrate.
